(19) United States
(12) Patent Application Publication
(10) Pub. No.: US 2013/0337953 A1
(43) Pub. Date: Dec. 19, 2013

(54) PULLEY DEVICE FOR AN AIR CONDITIONING COMPRESSOR

(71) Applicants: Nicolas Berruet, Artannes sur Indre (FR); Richard Corbett, FONDETTES (FR); Samuel Viault, SAINT ANTOINE DU ROCHER (FR)

(72) Inventors: Nicolas Berruet, Artannes sur Indre (FR); Richard Corbett, FONDETTES (FR); Samuel Viault, SAINT ANTOINE DU ROCHER (FR)

(73) Assignee: AKTIEBOLAGET SKF, Goteborg (SE)

(21) Appl. No.: 13/901,746

(22) Filed: May 24, 2013

(30) Foreign Application Priority Data
May 24, 2012 (FR) 1254778

(51) Int. Cl. F16H 55/36

(52) U.S. Cl. CPC F16H 55/36
USPC 474/94

(57) ABSTRACT

Pulley device for a rotating machine comprising a pulley, a torque transmission means intended to be mounted on a rotating shaft of the rotating machine and a damping element arranged between the said pulley and the torque transmission means. The damping element is retained axially on the pulley by mechanical attachment means.

### CROSS-REFERENCE TO RELATED APPLICATIONS

This application claims priority to French patent application no. 1254778 filed May 24, 2012, the contents of which are fully herein incorporated by reference.

### FIELD OF THE INVENTION

The present invention relates to the field of devices for transmitting torque between a drive pulley device and a shaft driven by the pulley. A torque transmission device of this type may be utilized, in particular, in air conditioning compressors such as those which are installed in motor vehicles.

### BACKGROUND OF THE INVENTION

A drive belt, connected to the engine by means of a crankshaft pulley, may decelerate harshly, whereas a driven pulley, for example an alternator pulley, exhibits a tendency, due to inertia, to continue to rotate at the same speed.

In the case of a rigid attachment between the crankshaft pulley and the transmission shaft, the belt is subjected to very high stresses at the time of these instantaneous variations in speed. Such variations are able to generate abnormal fatigue in the belt, for example, with the associated risks of rupture, slipping of the belt on the pulley, or even vibration of the belt runs between the pulleys.

In order to mitigate these phenomena, means for limiting the torque have been incorporated between the driven pulley and the driven shaft, in order to counteract the adverse effects of any rotational irregularities or sudden decelerations of the engine which occur in internal combustion engines, in particular at low speeds and especially in diesel engines. In this manner, in the case of excessive torque resulting, for example, from seizure of the air conditioning compressor, the pulley may continue to rotate without driving the shaft or without slipping relative to the drive belt, which would rapidly result in the destruction of this belt.

A damping element may similarly be provided between the pulley and the transmission shaft, in order to filter the rotational irregularities of the engine and the vibrations due to the rotation of the transmission shaft.

Document EP 0 702 167 (Denso) describes a device for transmitting torque between a pulley and a transmission shaft by means of two retention means, arranged between which is an elastic ring.

A structure of this kind is difficult to implement, however, as a result of the utilization of several retention means, and does not permit sufficient filtering of the rotational irregularities of the engine or the vibrations of the transmission shaft. Furthermore, the damping element is not retained axially by the pulley.

Document FR 2 853 373 (Hutchinson) describes a pulley device comprising a pulley, a torque limiter and an elastic ring arranged between the pulley and the torque limiter. The elastic ring comprises a central annular core, radial projections extending towards the outside and capable of interacting with the pulley and radial projections extending towards the inside and capable of interacting with the torque limiter, so that the feet of the projections work under shear stress.

Such an elastic element does not permit the filtering of the rotational irregularities of the engine in an effective manner. Furthermore, the elastic element is heavily loaded in shearing, so that its service life is reduced. In addition, the damping element is not retained axially in the pulley device.

### SUMMARY OF THE INVENTION

The object of the present invention is thus to overcome these disadvantages.

The object of the present invention is a pulley device permitting the damping element to be retained effectively in the event of the disconnection of the torque limiter and the pulley.

The object of the present invention is similarly an air conditioning compressor capable of effectively filtering any rotational irregularities generated by the engine and transmitted to the belt and similarly integrating a system of torque transmission means, advantageously being a torque limiter. The service life of the belt is thus increased.

According to one embodiment, the invention relates to a pulley device for a rotating machine comprising a pulley, a means for the transmission of torque intended to be installed on a rotating shaft of the rotating machine and a damping element arranged between the said pulley and the said torque transmission means.

In accordance with the invention, the damping element is retained axially on the pulley by mechanical attachment means.

Advantageously, the mechanical attachment means are provided on the damping element and are accommodated in indentations made on the pulley. Alternatively, the mechanical attachment means are provided on the pulley and are accommodated in indentations made on the damping element.

Advantageously, the mechanical attachment means possess a form which matches that of the indentations which accommodate them.

Advantageously, the mechanical attachment means comprise a proximal portion extending axially via a distal portion exhibiting a straight section having a dimension greater than the section of the proximal portion.

The mechanical attachment means may comprise a plurality of axial pins regularly distributed in a circumferential manner and extending axially between the damping element and the pulley.

According to one embodiment, the axial pins exhibit the form of a dovetail capable of interacting with an indentation of corresponding form.

According to another embodiment, the axial pins exhibit a circular geometrical form capable of interacting with an indentation of corresponding form.

For example, the axial pins comprise a first cylindrical portion and a second cylindrical portion having a diameter greater than the first cylindrical portion.

According to another embodiment, the axial pins exhibit a conical form.

Advantageously, the pulley comprises a plurality of axial ribs and the damping element comprises recesses having a form corresponding to the axial ribs acting as supplementary mechanical attachment means.

The damping element may be overmoulded onto the pulley, and the mechanical attachment means or the indentations are formed at the time of the overmoulding of the damping element onto the pulley.

Thus, thanks to the particular form of the mechanical attachment means produced at the time of the overmoulding of the damping element onto the pulley, the damping element is effectively retained axially in the pulley. In fact, the process of overmoulding the damping element directly onto the pulley makes it possible to obtain mechanical attachment means having a form that is strictly complementary to the indentations or corresponding recesses, in which the material of the damping element is housed. Alternatively, the process of overmoulding the damping element directly onto the pulley makes it possible to obtain indentations having a form that is strictly complementary to the corresponding mechanical attachment means which are housed there in the material of the damping element.

The damping element may similarly be overmoulded onto the torque transmission means.

The damping element is made of an elastic material, for example, and an additive, such as a reticulating agent, may be added to the elastic material of the damping element, so as to strengthen the adhesion between the damping element and the pulley.

Advantageously, the torque transmission means is a torque limiter. In particular, this torque limiter may be provided with frangible means assuring the disconnection of the rotating shaft from the pulley in the case of a torque greater than a threshold value.

The invention similarly relates to a rotating machine comprising a hollow coaxial shaft, a transmission shaft and a pulley device according to any of the preceding embodiments.

### BRIEF DESCRIPTION OF THE DRAWINGS

Other aims, characteristics and advantages of the invention will become apparent from a reading of the following description, which is provided solely by way of example without limitation and is given with reference to the accompanying drawings, in which:

FIG. 1 is a front view of a pulley device according to a first embodiment of the invention;

FIG. 2 is a view in the cross-section II-II of the pulley device according to FIG. 1, installed on a shaft of an air conditioner for a motor vehicle;

FIG. 3 is a view in the cross-section III-III of the pulley device according to FIG. 2;

FIGS. 4 and 5 illustrate a damping element according to the first embodiment;

FIG. 6 is a cross-sectional view of a pulley device according to a second embodiment;

FIG. 7 is a view in the cross-section VIII-VIII of the pulley device according to FIG. 6;

FIG. 8 illustrates a damping element according to the second embodiment;

FIG. 9 is a cross-sectional view of the pulley device according to a third embodiment;

FIG. 10 is a perspective view of a damping element according to the third embodiment;

FIG. 11 is a cross-sectional view according to a fourth embodiment; and

FIG. 12 is a perspective view of a damping element according to the fourth embodiment.

### DETAILED DESCRIPTION OF THE INVENTION

As illustrated in the figures, the illustrative embodiment of the invention relative to a pulley device bearing the reference 1 in its entirety is intended to be installed in an air conditioning compressor on board a motor vehicle.

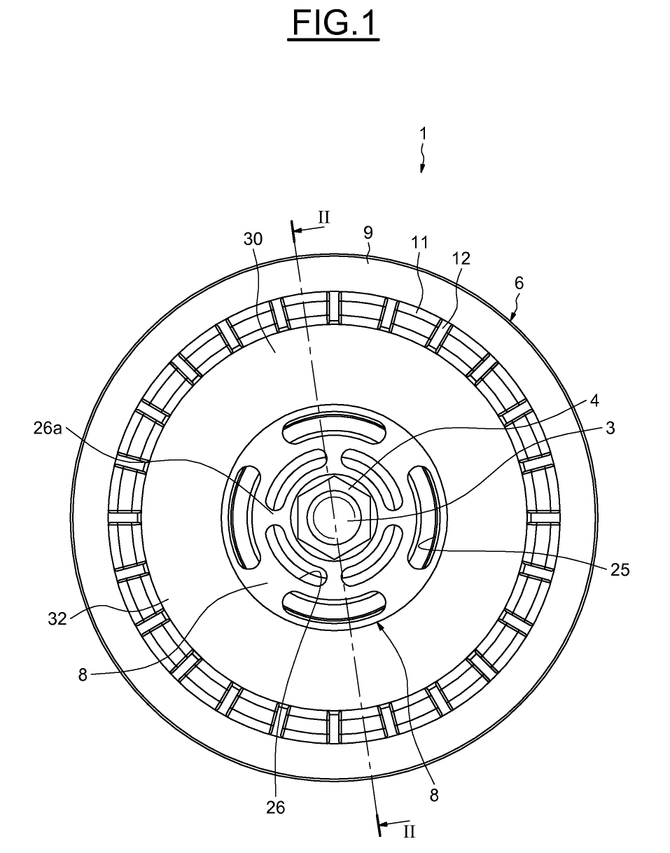

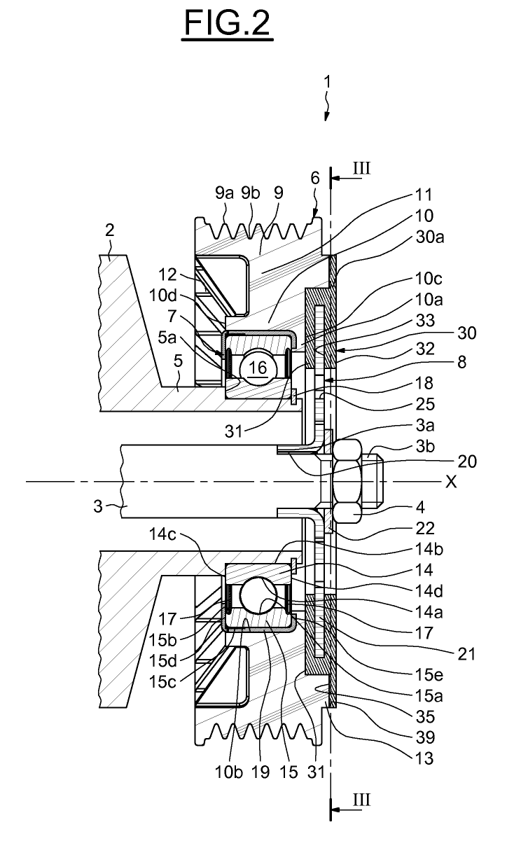

In the embodiment illustrated in FIGS. 1 and 2, the pulley device 1 is installed in a compressor comprising a non-rotating housing 2 and a transmission shaft 3 having an axis of rotation X. The transmission shaft 3, illustrated in detail in FIG. 2, comprises a shoulder 3a and a threaded portion 3b intended to interact with a nut 4. The housing 2 comprises a hollow shaft 5 that is coaxial with the transmission shaft 3.

As illustrated in the figures, the pulley device 1 comprises a pulley 6, a roller bearing 7 and a torque transmission means, being a torque limiter 8 in the example presented here.

More precisely, the pulley 6 comprises an outer axial portion 9 presenting an outside surface intended to interact with a belt or a chain (not illustrated), an inner axial portion 10 and an intermediate radial annular portion 11 connecting the said inner and outer portions 9, 10. The outer and inner portions 9, 10 are coaxial with the axis of rotation X. The inner axial portion 10 comprises a radial rim 10a facing radially towards the inside from its axial extremities, a bore 10b in which the roller bearing 7 can be housed, and two lateral surfaces 10c, 10d. Reinforcing ribs 12 are similarly provided between the inner and outer axial portions 9, 10 and are connected together on the intermediate portion 11.

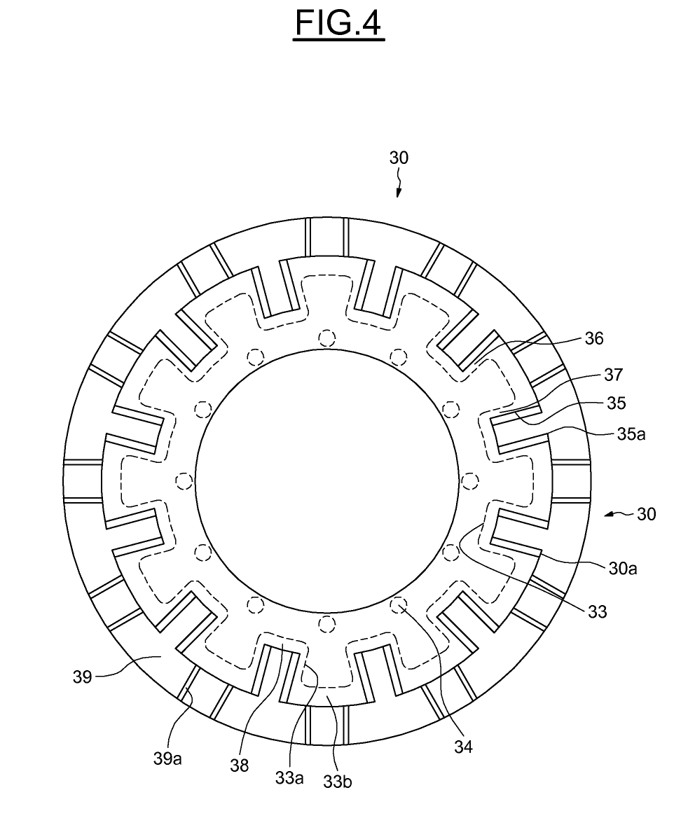

The outer cylindrical surface of the outer axial portion 9 is equipped with ribs 9a defining between them throats 9b, on the inside of which are accommodated V-belts or a single belt containing corresponding ribs, the said belt not being illustrated in the figures. One of the lateral surfaces 10c of the pulley 6, opposite the housing 2, comprises a plurality of axial ribs 13, for example of square or rectangular form, extending axially from the lateral radial surface 10c of the side opposite the housing 2 towards the outside. The axial ribs 13, which are visible in detail in FIG. 4, are distributed regularly in the circumferential direction of the lateral radial surface 10c. Two adjacent ribs 13 are separated by an indentation 13a made in the thickness of the lateral radial surface 10c.

The roller bearing 7 contains an inner ring 14, an outer ring 15, a row of rolling elements 16, in this case realized in the form of balls, arranged between bearing raceways 14a, 15a for the rings 14, 15, a cage (not illustrated) assuring the maintenance of the circumferential spacing of the rolling elements 16, and two sealing joints 17 that are symmetrical in relation to a radial plane passing through the centre of the rolling elements 16.

The inner ring 14 contains an outside circular axial surface, in which are arranged the toroidal bearing raceway 14a for the rolling elements 16, a bore 14b in contact with the outer cylindrical surface of the hollow shaft 5 and two lateral radial surfaces 14c, 14d. One of the lateral surfaces 14c is in axial contact with a shoulder 5a of the hollow shaft 5, and the other lateral surface 14d is in axial contact with an axial retention means 18, such as a circlip, for example.

The outer ring 15 is equipped with a bore, in which are arranged the toroidal bearing raceway 15a for the rolling elements 16, and grooves 15b, into which the sealing joints 17 are pressed, an outside circular axial surface 15c being pressed into the bore 10b of the pulley 6 via the intermediary of an annular flange 19 in the form of an L and two lateral radial surfaces 15d, 15e. One of the lateral surfaces 15e bears axially against the radial rim 10a of the pulley 6. The annular flange 19 comprises an axial portion (not referenced) intended to be folded in order to retain the outer ring 15 of the roller bearing 7 axially. As an alternative, the pulley 6 could be obtained by overmoulding directly onto the outer ring 15 of a plastic material, such as a polyamide. This results in an excellent cohesion between these components. The realization of the pulley 6 by moulding permits it to be given complex forms while maintaining considerable lightness and relatively low manufacturing costs. Of course, the pulley 6 could be made of sheet metal as an alternative and could be pressed directly onto the outer ring 15.

As illustrated, the torque limiter 8, made by stamping a metal sheet, comprises an axial sleeve 20 and a radial plate 21 extending radially from the axial sleeve 20 towards the outside. The radial plate 21 and the axial sleeve 20 form a single component. The axial sleeve 20 is attached to the transmission shaft 3 in the vicinity of the extremity of the shaft between the shoulder 5a and the nut 6 via a washer 22. The radial plate 21 exhibits the general form of a disc and comprises a plurality of regularly distributed radial teeth 23 extending radially towards the outside. Two adjacent teeth 23 are separated in the circumferential direction by an indentation 24.

The radial plate 21 in addition comprises a first series of transcurrent drillings 25 of elongated form, for example being four in number, which are regularly distributed circumferentially and are angularly equidistant one from the other, in order to permit the insertion of an assembly tool (not illustrated). As an alternative, a different number of drillings or drillings of different form could be provided. The radial plate 21 similarly comprises a second series of transcurrent drillings 26 of elongated form, for example being four in number, which are angularly equidistant one from the other, centred on the same circle and arranged between the first series of drillings 25 and the axial sleeve 20. Two adjacent drillings 26 are spaced circumferentially by a portion 26a intended to rupture when the torque transmitted by the pulley 6 to the transmission shaft 3 exceeds a threshold value, for example 50 Nm.

The pulley device 1 comprises a damping element 30 arranged between the pulley 6 and the torque limiter 8, in order to filter the rotational irregularities of the engine and the vibrations of the transmission shaft 3.

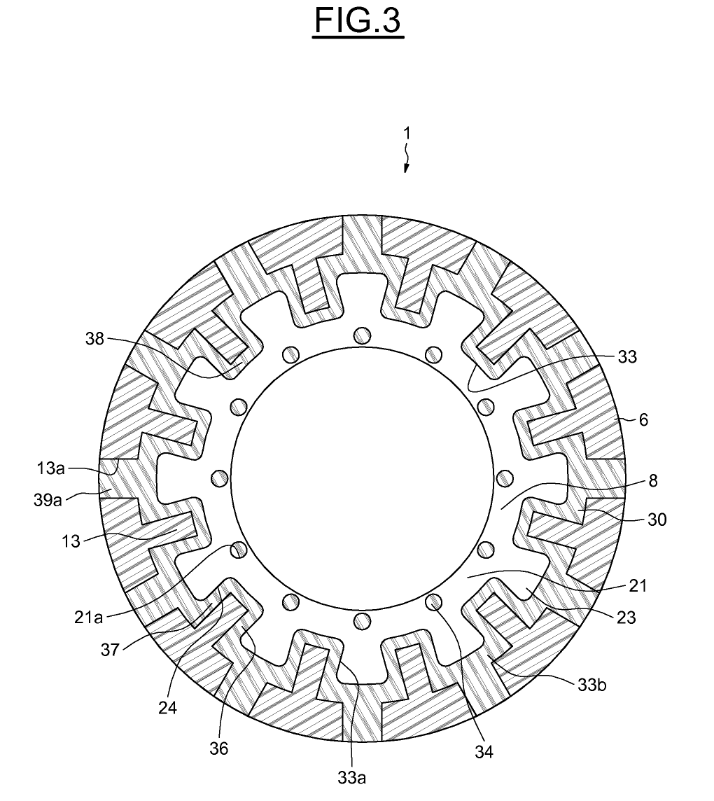

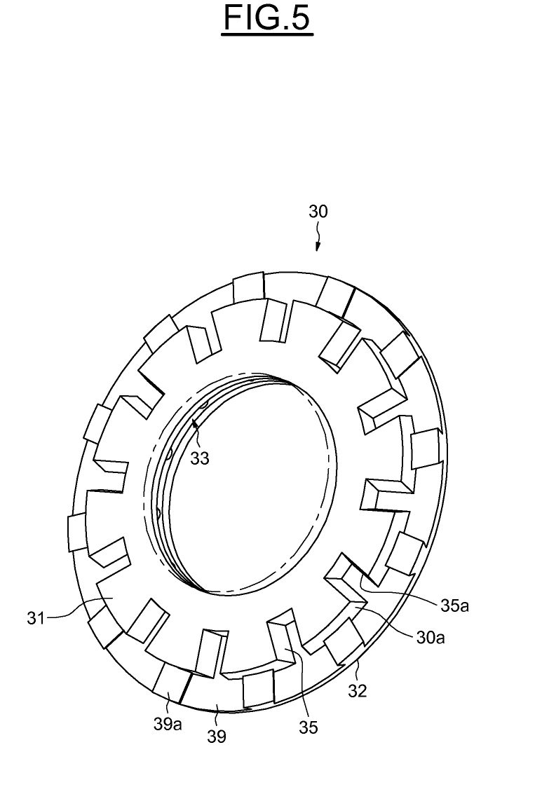

As illustrated in FIGS. 1 to 5, the damping element 30 exhibits the general form of a crown comprising a first lateral wall 31 and a second lateral wall 32, situated between which is an inner housing 33 made in its thickness emerging radially into a bore (not referenced) having a diameter greater than the diameter of the transmission shaft. The inner housing 33 exhibits a form which matches that of the radial plate 21 of the torque limiter 8, that is to say that the inner housing 33 exhibits a plurality of cavities 33a in the form of a dovetail, in which cavities the teeth 23 of the radial plate 21 of the torque limiter 8 are housed. As an alternative, the teeth 23 and the corresponding cavities 33a could have any other form, such as rectangular, for example. The first lateral wall 31 bears axially against the lateral radial surface 10c of the pulley 6, and the second lateral wall 32 faces towards the outside of the pulley device 1.

The damping element 30, made of an elastic material such as thermoplastic elastomer (TPE), for example, is overmoulded onto the torque limiter 8 and comprises for this purpose axial overmoulding pads 34 extending axially into the inner housing 33 between the walls 31, 32 of the damping element 30 in order to interact with corresponding drillings 21a made in the radial plate 21 of the torque limiter 8.

The damping element 30 comprises a plurality of recesses 35, each intended to interact with an axial rib 13 of the pulley 6. Each recess 35 exhibits a form which matches that of the corresponding axial rib 13 and emerges via an opening 35a on the peripheral outside surface 30a of the damping element 30. As illustrated, the recess 35 is not transcurrent. The recesses 35 having a form corresponding to the axial ribs 13 of the pulley 6 play the role of supplementary mechanical attachment means.

In the illustrated example, the damping element 30 comprises two damping portions 36, 37 arranged in each of the indentations 24 of the radial plate 21. Each damping portion 36, 37 is situated circumferentially between a radial tooth 23 of the torque limiter 8 and an axial rib 13 of the pulley 6, to either side of the recess 35. The circumferential position of the damping portions 36, 37 between a radial tooth 23 and an axial rib 13 permits these damping portions to work only in compression.

As illustrated, the damping portions 36, 37 are of substantially equal thickness when the device is at rest. As an alternative, provision could be made for a single unique damping portion between a tooth 23 of the torque limiter 8 and an axial rib 13 of the pulley 6.

The inner housing 33 of the damping element 30 delimits a radial portion 38 for the absorption of vibrations situated radially between an inner peripheral surface 24a of an indentation 24 of the torque limiter 8 and an axial rib 13 of the pulley 6 and circumferentially between two adjacent radial teeth 23.

In the example illustrated in FIGS. 1 to 5, the cavities 33a of the inner housing 33 are delimited radially by an outer radial portion 33b.

The damping element 30 comprises a supplementary plane annular wall 39 surrounding the outer radial portions 33b and comprising a plurality of protrusions 39a exhibiting the form of a dovetail having a form that is complementary to the indentations 13a made on the pulley 6. Each protrusion 39a comprises a proximal portion extending axially from the outside surface of the supplementary wall 39 towards the pulley 6 via a distal portion exhibiting a straight section having a dimension greater than the dimension of the straight section of the proximal portion. Thus, the damping element 30 is effectively retained axially in the pulley 6 by the mechanical attachment means produced by the protrusions in the form of a dovetail 39b.

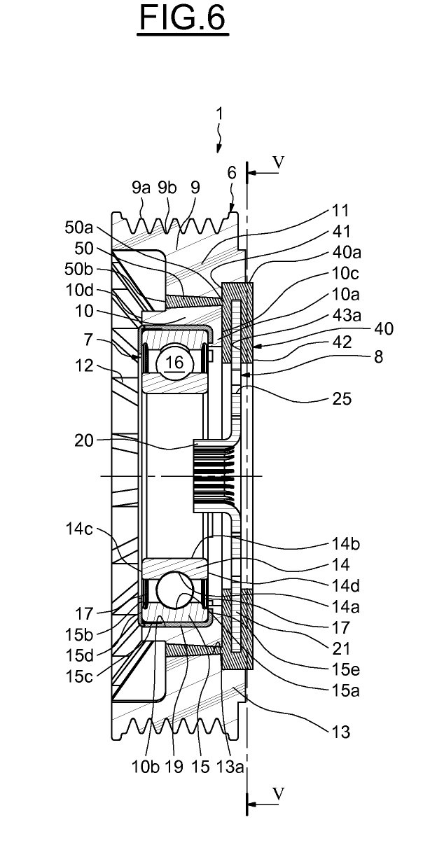

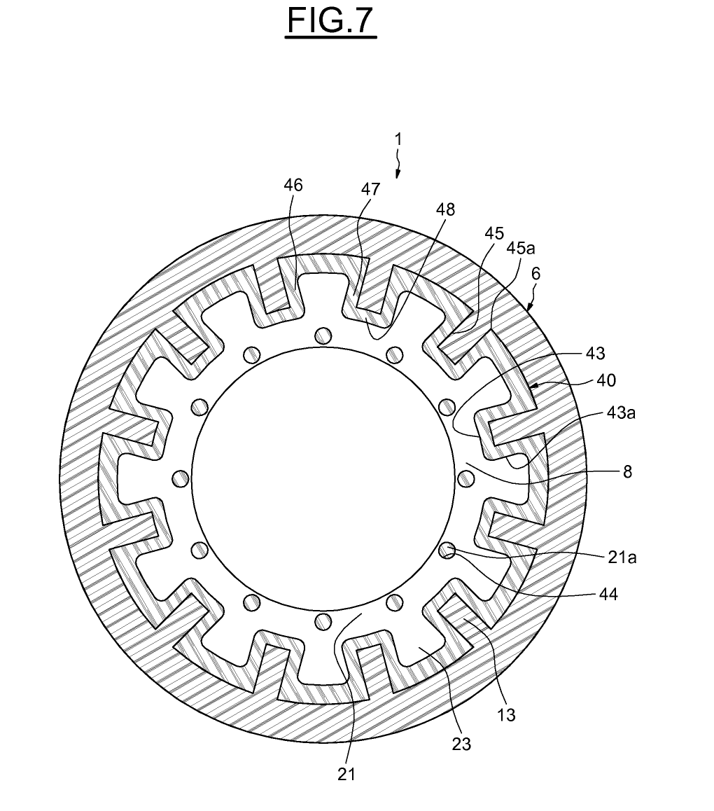

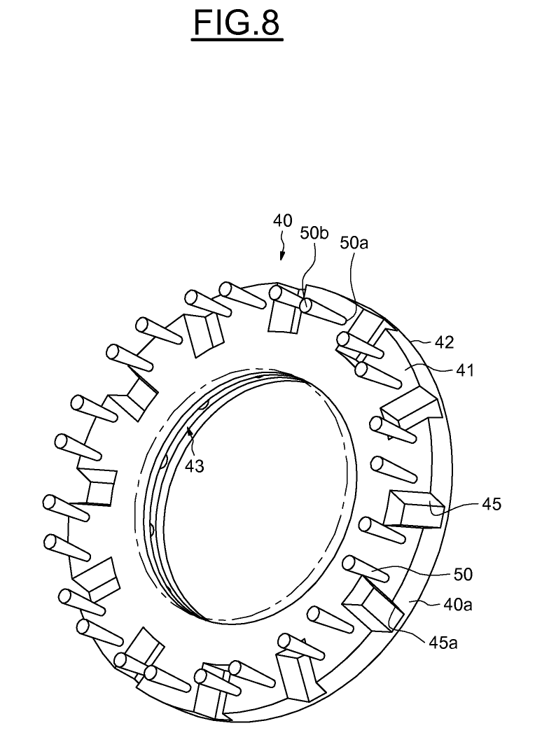

The embodiments illustrated in FIGS. 6 to 10, in which the same elements have the same references, differ from the embodiment illustrated in FIGS. 1 to 5 by the form of the damping element 30.

As illustrated in FIGS. 6 to 8, the damping element 40 exhibits the general form of a crown comprising a first lateral wall 41 and a second lateral wall 42, situated between which is an inner housing 43 made in the thickness thereof and emerging radially into a bore (not referenced) having a diameter greater than the diameter of the transmission shaft. The inner housing 43 possesses a form which matches that of the radial plate 21 of the torque limiter 8, that is to say that the inner housing 43 exhibits a plurality of cavities 43a in the form of a dovetail, in which the teeth 23 of the radial plate 21 of the torque limiter 8 are housed.

The damping element 40, made of an elastic material such as thermoplastic elastomer (TPE), for example, is overmoulded onto the torque limiter 8 and comprises for this purpose axial overmoulding pads 44 extending axially into the inner housing 43 between the walls 41, 42 of the damping element 40 in order to interact with corresponding drillings 21a made in the radial plate 21 of the torque limiter 8. The extremity of each radial tooth 23 is in contact with an outer radial portion 33b of the damping element 40. As an alternative, provision could be made for the cavities 43a of the inner housing 43 to emerge via an opening towards the outside of the damping element 40, so that the teeth 23 of the torque limiter 8 extend radially as far as the outer peripheral surface 40a of the damping element 40.

The damping element 40 comprises a plurality of recesses 45, each intended to interact with an axial rib 13 of the pulley 6. Each recess 45 possesses a form which matches that of the corresponding axial rib 13 and does not emerge on the outer peripheral surface 40a of the damping element 40. As an alternative, provision could be made for the recess 45 to emerge on the peripheral surface 40a of the damping element 40. As illustrated, the recess 45 is not transcurrent. The recesses 45 possessing a form corresponding to the axial ribs 13 of the pulley 6 play the role of supplementary mechanical attachment means.

In the illustrated example, the damping element 40 comprises two damping portions 46, 47 arranged in each of the indentations 24 of the radial plate 21. Each damping portion 46, 47 is situated circumferentially between a radial tooth 23 of the torque limiter 8 and an axial rib 13 of the pulley 6, to either side of the recess 45. The circumferential position of the damping portions 46, 47 between a radial tooth 23 and an axial rib 13 permits these damping portions to work only in compression.

As illustrated, the damping portions 46, 47 are of substantially equal thickness.

The inner housing 43 of the damping element 40 delimits an inner radial portion (not referenced) for the absorption of any vibrations, situated radially between an inner peripheral surface 24a of an indentation 24 of the torque limiter 8 and an axial rib 13 of the pulley 6 and circumferentially between two adjacent radial teeth 23.

The damping element 40 comprises mechanical attachment means 50 containing a plurality of axial pins distributed regularly over the circumference of the damping element 40, in particular at the level of the portion situated between two recesses 45. Each pin 50 extends axially from the first lateral wall 41 of the damping element towards the pulley 6 and exhibits a circular geometrical form, such as a cone. Each cone 50 comprises a proximal portion 50a exhibiting a straight section having a diameter greater than the diameter of the straight section of the distal portion 50b.

In the illustrated example, two conical pins 50 are arranged at the level of the portion between two recesses 45. As an alternative, provision could be made for the arrangement of a single conical pin in this same portion.

The damping element 40, made of an elastic material such as thermoplastic elastomer (TPE), for example, is overmoulded onto the torque limiter 8 and the pulley 6, so that the conical pins 50 are produced at the time of the overmoulding of the damping element 40 onto the pulley 6. The conical pins 50 have a form that is complementary to the indentations 13a made on the pulley 6 and permit the axial retention of the damping element 40 on the pulley 6, in particular in the event of the rupture of the torque limiter 8.

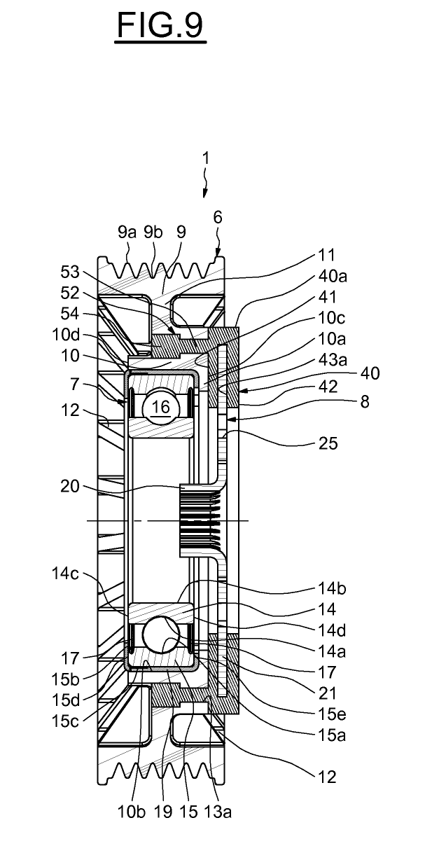

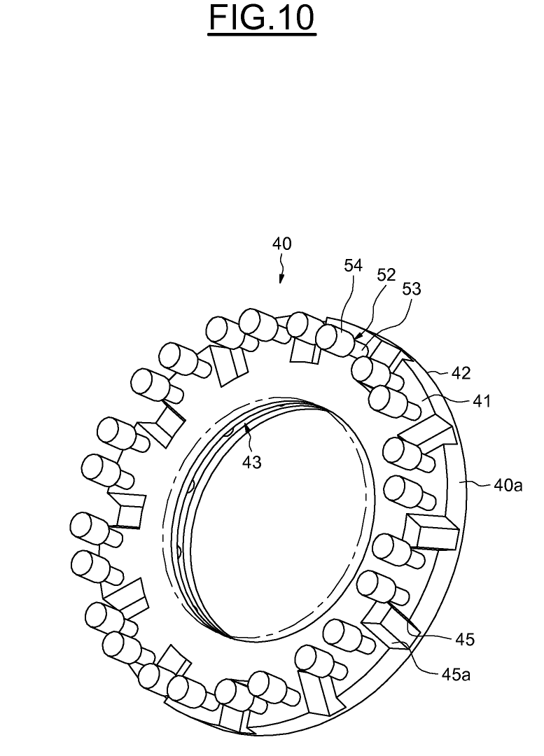

The embodiment illustrated in FIGS. 9 and 10, in which the same elements have the same references, differs from the embodiment illustrated in FIGS. 6 to 8 only by the form of the mechanical attachment means of the damping element 40.

As illustrated in FIGS. 9 and 10, the damping element 40 comprises mechanical attachment means 52 containing a plurality of axial pins regularly distributed over the circumference of the damping element 40, in particular at the level of the portion situated between two recesses 45. Each axial pin 52 extends axially from the first lateral wall 41 of the damping element towards the pulley 6 and exhibits a circular geometrical form such as a cylinder. Each axial pin 52 comprises a first proximal cylindrical portion 53, in proximity to the first lateral wall 41, and a second distal cylindrical portion 54 having a diameter greater than the diameter of the first cylindrical portion 53.

In the illustrated example, two cylindrical pins 52 are arranged at the level of the portion between two recesses 45. As an alternative, provision could be made to arrange a single conical pin in this same portion.

The damping element 40 is overmoulded onto the torque limiter 8 and the pulley 6, so that the cylindrical pins 52 are produced at the time of the overmoulding of the damping element 40 onto the pulley 6. The cylindrical pins 52 have a form that is complementary to the indentations 13a made on the pulley 6 and permit the axial retention of the damping element 40 on the pulley 6, in particular in the event of the rupture of the torque limiter 8.

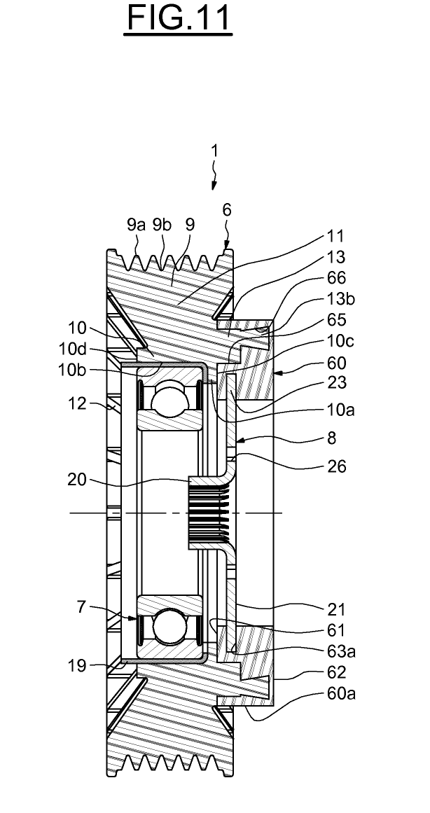

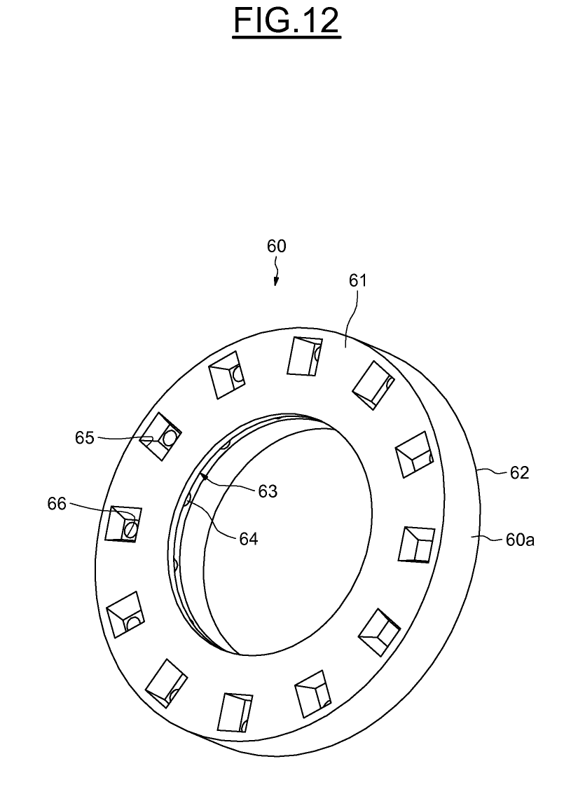

The embodiments illustrated in FIGS. 11 and 12, in which the same elements have the same references, differ from the embodiment illustrated in FIGS. 1 to 5 by the form of the damping element and the form of the pulley.

As illustrated in FIG. 11, the pulley 6 comprises an outer axial portion 9 presenting an outside surface intended to interact with a belt or a chain (not illustrated), an inner axial portion 10 and an annular radial intermediate portion 11 connecting the said inner and outer portions 9, 10 together. The outer and inner portions 9, 10 are coaxial with the axis of rotation X. The inner axial portion 10 comprises a radial rim 10a facing radially towards the inside from its axial extremities, a bore 10b in which the roller bearing 7 can be housed, and two lateral surfaces 10c, 10d. Reinforcing ribs 12 are similarly provided between the axial inner and outer portions 9, 10 and are connected together on the intermediate portion 11.

The outer cylindrical surface of the outer axial portion 9 is equipped with ribs 9a defining between them throats 9b, on the inside of which are accommodated V-belts or a single belt containing corresponding ribs, the said belt not being illustrated in the figures. One of the lateral surfaces 10c of the pulley 6 opposite the housing 2 comprises a plurality of axial ribs 13, for example of square or rectangular form, extending axially from the lateral radial surface 10c on the side opposite the housing 2 towards the outside. The axial ribs 13 are regularly distributed in the circumferential direction of the lateral radial surface 10c. Each axial rib 13 comprises an axial projection or an axial pin 13b extending axially from the lateral surface of the axial rib 13 towards the outside and exhibits a circular geometrical form such as a cylinder. Each axial projection 13b comprises a first cylindrical proximal portion, in proximity to the lateral surface of the axial rib 13, and a second cylindrical distal portion having a diameter greater than the diameter of the first cylindrical portion.

The damping element 60 exhibits the general form of a crown comprising a first lateral wall 61 and a second lateral wall 62, situated between which is an inner housing 63 made in the thickness thereof and emerging radially into a bore (not referenced) having a diameter greater than the diameter of the transmission shaft. The inner housing 63 possesses a form which matches that of the radial plate 21 of the torque limiter 8, that is to say that the inner housing 63 exhibits a plurality of cavities 63a in the form of a dovetail, in which the teeth 23 of the radial plate 21 of the torque limiter 8 are housed. The damping element 60, made of an elastic material such as thermoplastic elastomer (TPE), for example, is overmoulded onto the torque limiter 8 and comprises for this purpose axial overmoulding pads 64 extending axially into the inner housing 63 between the walls 61, 62 of the damping element 60 in order to interact with corresponding drillings (not illustrated) made in the radial plate 21 of the torque limiter 8. The extremity of each radial tooth 23 is in contact with an outer radial portion of the damping element 60. As an alternative, provision could be made for the cavities 63a of the inner housing 63 to emerge via an opening towards the outside of the damping element 60, so that the teeth 23 of the torque limiter 8 extend radially as far as the peripheral outside surface 60a of the damping element 60.

The damping element 60 comprises a plurality of recesses 65, each intended to interact with an axial rib 13 of the pulley 6. Each recess 65 possesses a form which matches that of the corresponding axial rib 13 and extends via an axial indentation 66 having a form which matches that of the axial projections 13b of the pulley 6. As illustrated, the axial indentation 66 does not emerge on the outer peripheral surface 60a of the damping element 60. As an alternative, provision could be made for the axial indentation 66 to emerge on the peripheral surface 60a of the damping element 60. The recesses 65 and the axial indentations 66 having a form corresponding respectively to the axial ribs 13 and to the axial projections 13b of the pulley 6 play the role of mechanical attachment means.

In the example illustrated in FIGS. 11 and 12, the damping element 60 is retained axially on the pulley 6 by the mechanical attachment means produced by the axial projections 13b and accommodated in the axial indentations 66 made on the damping element 60.

In the illustrated example, the damping element 60 comprises two damping portions (not referenced) arranged in each of the indentations 24 of the radial plate 21. Each damping portion is situated circumferentially between a radial tooth 23 of the torque limiter 8 and an axial rib 13 of the pulley 6, to either side of the recess 65. The circumferential position of the damping portions between a radial tooth 23 and an axial rib 13 permits these damping portions to work only in compression.

The internal housing 63 of the damping element 60 delimits an internal radial portion (not referenced) for the absorption of vibrations situated radially between an inner peripheral surface 24a of an indentation 24 of the torque limiter 8 and an axial rib 13 of the pulley 6 and circumferentially between two adjacent radial teeth 23.

In each of the embodiments, the damping element is overmoulded onto the torque limiter and onto the pulley. As an alternative, provision could be made for the damping element to be overmoulded only onto the pulley.

Furthermore, in each of the embodiments described, the elastic material of the damping element 30, 40, 60 may be supplemented by an additive, such as a reticulating agent, for example, in order to strengthen the adhesion between the pulley 6 and the damping element 30, 40, 60.

The invention is not restricted to the embodiments described here and may be subject to various alternatives.

Thanks to the invention, it is possible to manufacture and assemble, in a simple, economic and easy manner, a unit made up of the pulley, the bearing, the torque limiter and the damping element, the said unit being capable of being transported subsequently without the risk of disconnection of these elements and being ready to be attached to the associated support.

The invention may be applied advantageously to a rotating machine comprising a hollow coaxial shaft 5, a transmission shaft 3 and a pulley device 1 according to one of the preceding embodiments.

In addition, the particular form of the damping element makes it possible for some of the circumferentially situated elastic material to be present between a tooth of the torque limiter and a rib of the pulley and for it to work only in compression. Thus, the rotational irregularities of the engine and the vibrations are effectively filtered by the damping element.

Thanks to the particular form of the mechanical attachment means produced at the time of the overmoulding of the damping element onto the pulley, the damping element is effectively retained axially in the pulley. In fact, the process of overmoulding the damping element directly onto the pulley makes it possible to obtain mechanical attachment means having a form that is strictly complementary to the corresponding indentations or recesses, in which the material of the damping element is housed.

1. A pulley device for a rotating machine comprising:
a pulley,
a means for the transmission of torque intended to be installed on a rotating shaft of the rotating machine and
a damping element arranged between the pulley and the torque transmission means, wherein
the damping element is axially retained on the pulley by mechanical attachment means.

2. The pulley device according to claim 1, wherein the mechanical attachment means are provided on the damping element and are accommodated in indentations made on the pulley.

3. The pulley device according to claim 1, wherein the mechanical attachment means are provided on the pulley and are accommodated in indentations made on the damping element.

4. The pulley device according to claim 1, wherein the mechanical attachment means possesses a form that matches the indentations.

5. The pulley device according to claim 1, wherein the mechanical attachment means includes a proximal portion extending axially via a distal portion exhibiting a straight section having a dimension greater than the section of the proximal portion.

6. The pulley device according to claim 1, wherein the mechanical attachment means includes a plurality of axial pins regularly distributed in a circumferential manner and extending axially between the damping element and the pulley.

7. The pulley device according to claim 6, wherein the axial pins exhibit the form of a dovetail capable of interacting with an indentation of corresponding form on the pulley.

8. The pulley device according to claim 6, wherein the axial pins exhibit a circular geometrical form capable of interacting with an indentation of corresponding form.

9. The pulley device according to claim 8, wherein the axial pins include a first cylindrical portion and a second cylindrical portion having a diameter greater than the first cylindrical portion.

10. The pulley device according to claim 8, wherein the axial pins exhibit a conical form.

11. The pulley device according to claim 1, wherein the pulley provides a plurality of axial ribs and the damping element includes recesses having a form corresponding to the axial ribs acting as supplementary mechanical attachment means.

12. The pulley device according to claim 1, wherein the damping element is overmoulded onto the pulley, and the mechanical attachment means are formed at the time of the overmoulding of the damping element onto the pulley.

13. The pulley device according to claim 1, wherein the damping element is overmoulded onto the torque transmission means.

14. The pulley device according to claim 1, wherein the damping element is made of an elastic material.

15. The pulley device according to claim 14, wherein a reticulating agent is added to the elastic material.

16. A rotating machine comprising:
a hollow coaxial shaft,
a transmission shaft, and
a pulley device, the pulley device including;
a pulley,
a means for the transmission of torque intended to be installed on a rotating shaft of the rotating machine and
a damping element arranged between the pulley and the torque transmission means, wherein
the damping element is axially retained on the pulley by mechanical attachment means.
